(19) United States
(12) Patent Application Publication
(10) Pub. No.: US 2025/0149232 A1
(43) Pub. Date: May 8, 2025

(54) METHOD FOR FORMING MAGNETIC ELEMENT, MAGNETIC ELEMENT AND TRANSFORMER

(71) Applicant: Delta Electronics (Shanghai) Co.,Ltd., Shanghai (CN)

(72) Inventors: Pengyao WEI, Shanghai (CN); Chienmi HUANG, Shanghai (CN)

(21) Appl. No.: 18/740,502

(22) Filed: Jun. 11, 2024

(30) Foreign Application Priority Data
Nov. 2, 2023 (CN) 202311452123.4

(51) Int. Cl. H01F 27/28; H01F 41/02; H01F 41/061

(52) U.S. Cl. CPC H01F 27/2847; H01F 27/2804; H01F 41/0266; H01F 41/061

(57) ABSTRACT

The disclosure discloses a method for forming a magnetic element, a magnetic element and a transformer. The magnetic element includes a plurality of conductive layers, each including a first conductive sheet, a second conductive sheet, and a first glue portion disposed between the first conductive sheet and the second conductive sheet for fixing and insulating the first conductive sheet and the second conductive sheet; and a plurality of second glue portions, each including an annular outer wall, and the plurality of second glue portions being alternatively arranged with the plurality of conductive layers, wherein each of the conductive layers is injection moulded by the first conductive sheet and the second conductive sheet through a first mould, and the magnetic element is injection moulded by the plurality of conductive layers through a second mould.

### CROSS-REFERENCE TO RELATED APPLICATIONS

This non-provisional application claims priority under 35 U.S.C. § 119(a) on patent application Ser. No. 202311452123.4 filed in P.R. China on Nov. 2, 2023, the entire contents of which are hereby incorporated by reference.

Some references, if any, which may include patents, patent applications and various publications, may be cited and discussed in the description of this application. The citation and/or discussion of such references, if any, is provided merely to clarify the description of the present application and is not an admission that any such reference is “prior art” to the application described herein. All references listed, cited and/or discussed in this specification are incorporated herein by reference in their entireties and to the same extent as if each reference was individually incorporated by reference.

### BACKGROUND OF THE DISCLOSURE

### 1. Field of the Disclosure

The disclosure relates to the technical field of magnetic elements, and particularly to a method for forming a magnetic element, a magnetic element and a transformer.

### 2. Related Art

Currently, switching power supplies tend to high efficiency and high power density, and how to reduce labor cost and implement automatic production are the problems that must be considered by engineers for designing magnetic elements.

The existing magnetic element includes a metal layer provided with an insulating tape between metal sheets, and a winding bobbin provided with a convex portion and a concave portion, the convex portion and the metal layer are fixedly combined manually to obtain magnetic assemblies, and then every two magnetic assemblies are engaged through the concave portion to obtain a magnetic element. Further, coils are manually winded onto the magnetic element, and assembled onto magnetic columns of the magnetic core to obtain a transformer, and finally, the transformer is corrected using a jig, such that the transformer is formed.

### SUMMARY OF THE DISCLOSURE

An object of the disclosure is to provide a magnetic element.

In order to achieve the object, the disclosure provides a method for forming a magnetic element, including: providing a first sub-mould and a second sub-mould, the first sub-mould including a first locating slot, a first locating surface, a second locating slot and a second locating surface; providing a first conductive sheet and a second conductive sheet both including a conductive body and a conductive pin; fixing the conductive body of the first conductive sheet to the first locating surface, fixing the conductive pin of the first conductive sheet to the first locating slot, fixing the conductive body of the second conductive sheet to the second locating surface, and fixing the conductive pin of the second conductive sheet to the second locating slot; obtaining a first mould after the first sub-mould and the second sub-mould are combined, and injecting a first glue into the first mould, the first conductive sheet, the second conductive sheet and the first glue forming a conductive layer; providing a third sub-mould, a fourth sub-mould and a fifth sub-mould, the third sub-mould including a plurality of third locating slots; preparing a plurality of conductive layers fixed to the plurality of third locating slots, each of the conductive layers having a first through hole, the fifth sub-mould penetrating into the first through hole of the plurality of conductive layers; and obtaining a second mould after the third sub-mould, the fourth sub-mould and the fifth sub-mould are combined, and injecting a second glue into the second mould, the plurality of conductive layers and the second glue forming the magnetic element.

In order to achieve the object, the disclosure provides a magnetic element, including: a plurality of conductive layers, each including: a first conductive sheet; a second conductive sheet; and a first glue portion disposed between the first conductive sheet and the second conductive sheet for fixing and insulating the first conductive sheet and the second conductive sheet; and a plurality of second glue portions, each including an annular outer wall, and the plurality of second glue portions being alternatively arranged with the plurality of conductive layers, wherein each of the conductive layers is injection moulded by the first conductive sheet and the second conductive sheet through a first mould, and the magnetic element is injection moulded by the plurality of conductive layers through a second mould.

In order to achieve the object, the disclosure provides a transformer, including: a magnetic core including magnetic columns; the magnetic element disposed on the magnetic columns; and a winding including a plurality of coil portions winded onto the plurality of integrated second glue portions, respectively.

### BRIEF DESCRIPTION OF THE DRAWINGS

To clearly explain the technical solution implemented by the disclosure, hereinafter the accompanying drawings used in the embodiments are simply introduced.

FIG. 1 is a structural diagram of a magnetic element according to some embodiments of the disclosure.

FIG. 2 is a structural diagram of conductive layers according to some embodiments of the disclosure.

FIG. 3 is a flow diagram of a method for forming a magnetic element of FIG. 1.

FIG. 4 is a schematic diagram of injection moulding of the conductive layers according to some embodiments of the disclosure.

FIG. 5 is a structural diagram of a first sub-mould according to some embodiments of the disclosure.

FIG. 6 is a schematic diagram of injection moulding of the magnetic element according to some embodiments of the disclosure.

FIG. 7 is a schematic diagram of fixing the conductive layers and a second mould according to some embodiments of the disclosure.

FIG. 8 is a schematic diagram of a winding winded onto a magnetic element of FIG. 1.

FIG. 9 is a first structural diagram of a transformer including the magnetic element of FIG. 1.

FIG. 10 is a second structural diagram of a transformer including the magnetic element of FIG. 1.

Additional aspects and advantages of the disclosure are partially explained in the below description, and partially become apparent from the description, or can be obtained from practice of the disclosure.

### DETAILED EMBODIMENTS OF THE DISCLOSURE

The exemplary embodiments will now be described more fully with reference to the accompanying drawings. However, the exemplary embodiments can be implemented in various forms and should not be understood as being limited to the embodiments set forth herein; on the contrary, these embodiments are provided so that this disclosure will be thorough and complete, and conception of the exemplary embodiments will be fully conveyed to those skilled in the art.

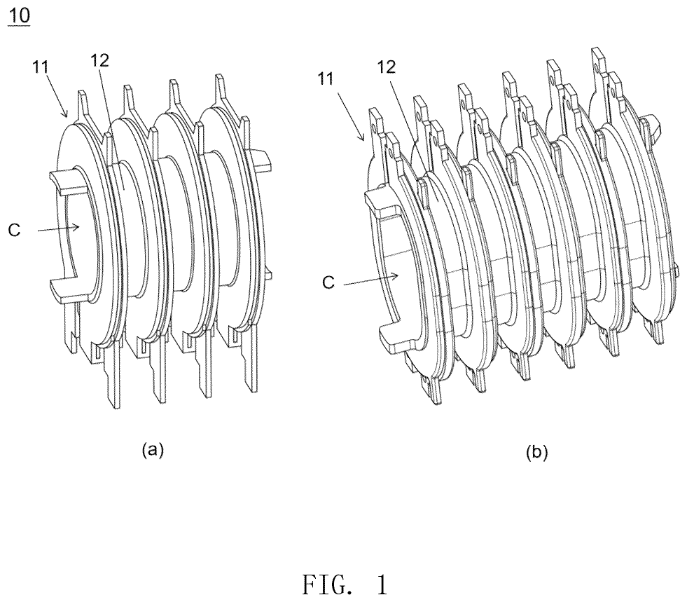

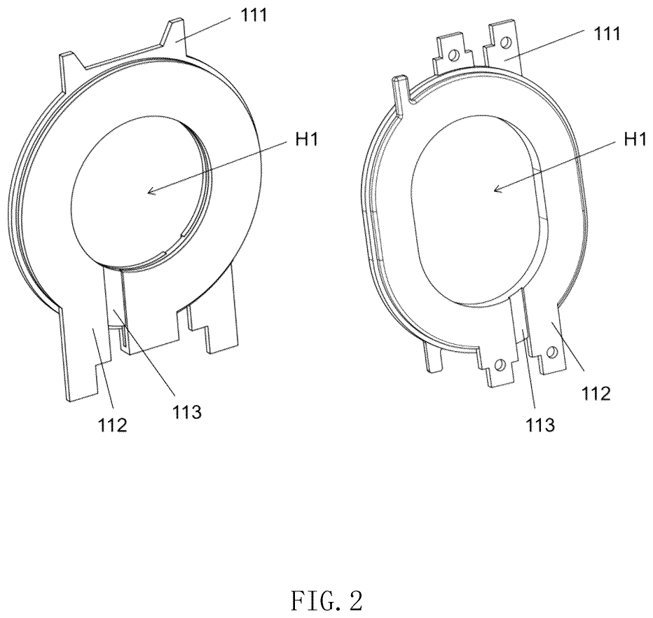

FIG. 1 is a structural diagram of a magnetic element 10 according to some embodiments of the disclosure. As shown in FIG. 1, FIG. 1 exemplary illustrates two different structures of the magnetic element 10, which are structures (a) and (b), and the magnetic element 10 may also have other structures. The structures (a) and (b) have similar structures, and include a plurality of conductive layers 11, a plurality of second glue portions 12 and a channel C. FIG. 2 is a structural diagram of conductive layers 11 in the structures (a) and (b). Referring to FIGS. 1 and 2, each of the conductive layers 11 includes a first conductive sheet 111, a second conductive sheet 112, and a first glue portion 113 disposed between the first conductive sheet 111 and the second conductive sheet 112 for fixing and insulating the first conductive sheet 111 and the second conductive sheet 112, and each of the conductive layers 11 has a first through hole H1. Each of the second glue portions 12 includes an annular outer wall, the plurality of second glue portions 12 are alternatively arranged with the plurality of conductive layers 11, and each of the second glue portions has second through holes correspondingly connected with each other to form a channel C. In some embodiments, the first glue portion 113 and the second glue portions 12 are thermoplastic materials, each of the conductive layers 11 is injection moulded by the first conductive sheet 111 and the second conductive sheet 112 through a first mould, and the magnetic element 10 is injection moulded by the plurality of conductive layers 11 through a second mould.

In some embodiments, the first conductive sheet 111 and the second conductive sheet 112 are metal sheets or PCB windings, and a tolerance of conductive pins between the plurality of conductive layers 11 is less than 0.1 mm.

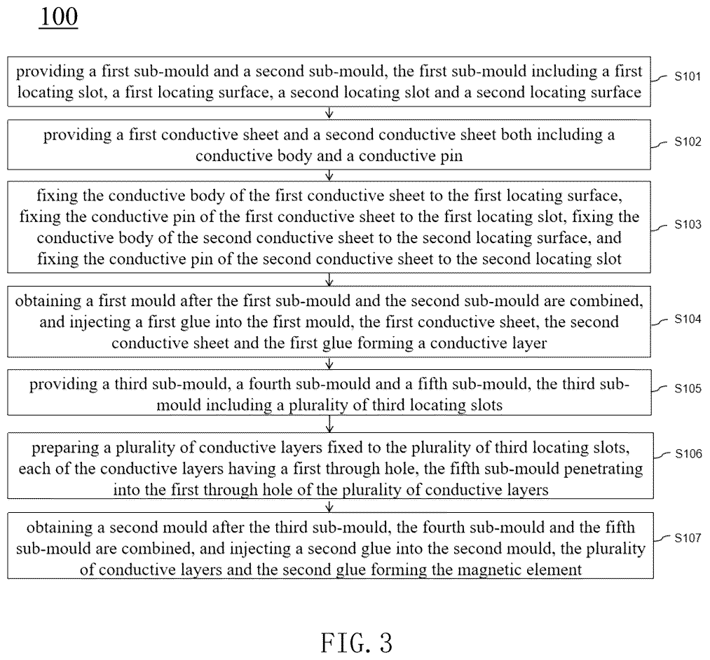

FIG. 3 is a flow diagram of a method 100 for forming a magnetic element 10 of FIG. 1, and the forming method 100 includes steps of:
S101: providing a first sub-mould and a second sub-mould, the first sub-mould including a first locating slot, a first locating surface, a second locating slot and a second locating surface;
S102: providing a first conductive sheet and a second conductive sheet both including a conductive body and a conductive pin;
S103: fixing the conductive body of the first conductive sheet to the first locating surface, fixing the conductive pin of the first conductive sheet to the first locating slot, fixing the conductive body of the second conductive sheet to the second locating surface, and fixing the conductive pin of the second conductive sheet to the second locating slot;
S104: obtaining a first mould after the first sub-mould and the second sub-mould are combined, and injecting a first glue into the first mould, the first conductive sheet, the second conductive sheet and the first glue forming a conductive layer;
S105: providing a third sub-mould, a fourth sub-mould and a fifth sub-mould, the third sub-mould including a plurality of third locating slots;
S106: preparing a plurality of conductive layers fixed to the plurality of third locating slots, each of the conductive layers having a first through hole, the fifth sub-mould penetrating into the first through hole of the plurality of conductive layers; and
S107: obtaining a second mould after the third sub-mould, the fourth sub-mould and the fifth sub-mould are combined, and injecting a second glue into the second mould, the plurality of conductive layers and the second glue forming the magnetic element.

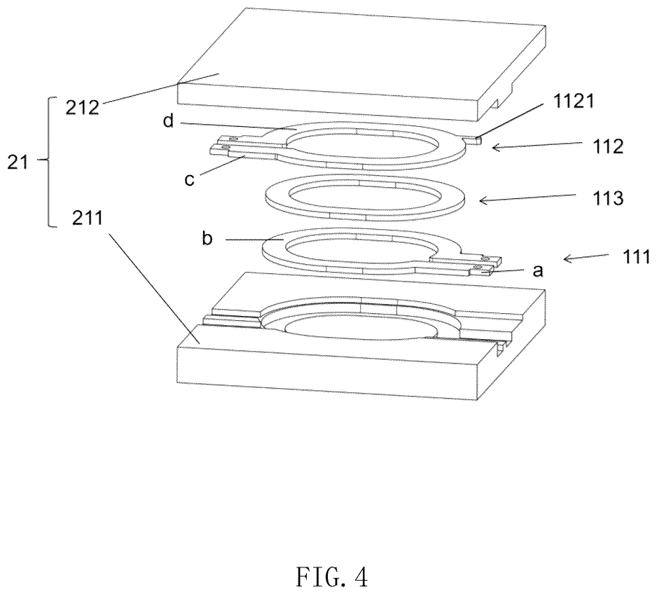

Hereinafter the method of forming the magnetic element 10, the mould structure and the use method are explained in details according to FIGS. 4 to 7.

FIG. 4 is a schematic diagram of injection moulding of the conductive layer 11. As shown in FIG. 4, a first mould 21 is provided, and includes a first sub-mould 211 and a second sub-mould 212, the second sub-mould 212 and the first sub-mould 211 are placed in an up and down form, and the conductive layer 11 through injection moulding of the first mould 21 is a horizontal structure.

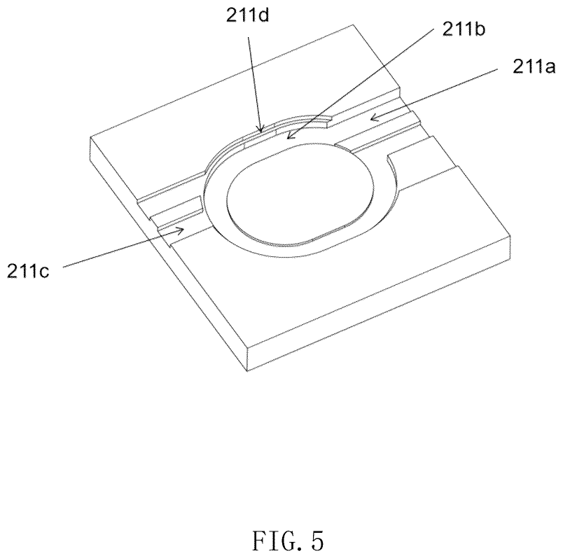

As for structure of the first sub-mould 211, please refer to FIG. 5. Referring to FIGS. 4 and 5, the first sub-mould 211 includes a first locating slot 211a, a first locating surface 211b, a second locating slot 211c and a second locating surface 211d. A first conductive sheet 111 including a conductive pin a and a conductive body b and a second conductive sheet 112 including a conductive pin c and a conductive body d are provided, shapes of the conductive body b of the first conductive sheet 111 and the first locating surface 211b are matched with each other, shapes of the conductive pin a of the first conductive sheet 111 and the first locating slot 211a are matched with each other, and shapes of the conductive pin c of the second conductive sheet 112 and the second locating slot 211c are matched with each other. The conductive body b of the first conductive sheet 111 is fixed to the first locating surface 211b, the conductive pin a of the first conductive sheet 111 is fixed to the first locating slot 211a, the conductive body d of the second conductive sheet 112 is fixed to the second locating surface 211d, and the conductive pin c of the second conductive sheet 112 is fixed to the second locating slot 211c.

In some embodiments of the disclosure, as shown in FIG. 4, the second conductive sheet 112 further includes a locating convex portion 1121 configured for location and fixing of wires of adjacent coil portions 41 when the adjacent coil portions 41 of a winding 40 are connected across the second conductive sheet 112 between the adjacent coil portions 41.

In the embodiment of FIG. 4, the conductive pin a of the first conductive sheet 111 and the conductive pin c of the second conductive sheet 112 are located on different sides, and in other embodiments, the conductive pin a of the first conductive sheet 111 and the conductive pin c of the second conductive sheet 112 may be located on the same side, and the structure of the first sub-mould is also adjusted correspondingly.

A first mould 21 is obtained after the first sub-mould 211 and the second sub-mould 212 are combined, and a glue is injected into the first mould 21. The glue is injected between the first conductive sheet 111 and the second conductive sheet 112 to form a first glue portion 113, the first conductive sheet 111 and the second conductive sheet 112 are fixed and insulated through the first glue portion 113, and the first conductive sheet 111, the second conductive sheet 112 and the first glue portion 113 form a conductive layer 11. A plurality of conductive layers 11 are prepared using the same method.

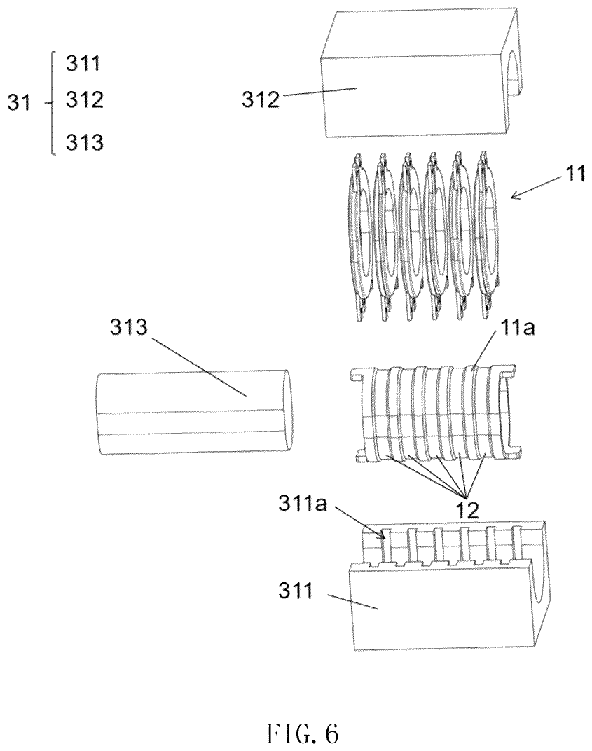

FIG. 6 is a schematic diagram of injection moulding of the magnetic element 10 according to some embodiments of the disclosure. As shown in FIG. 6, a third sub-mould 311 including a plurality of third locating slots 311a, a fourth sub-mould 312 including a plurality of fourth locating slots (Not shown in the figure), and a fifth sub-mould 313 are provided, and the plurality of fourth locating slots are arranged corresponding to the plurality of third locating slots 311a. In some embodiments, the fourth sub-mould 312 may not include the plurality of fourth locating slots.

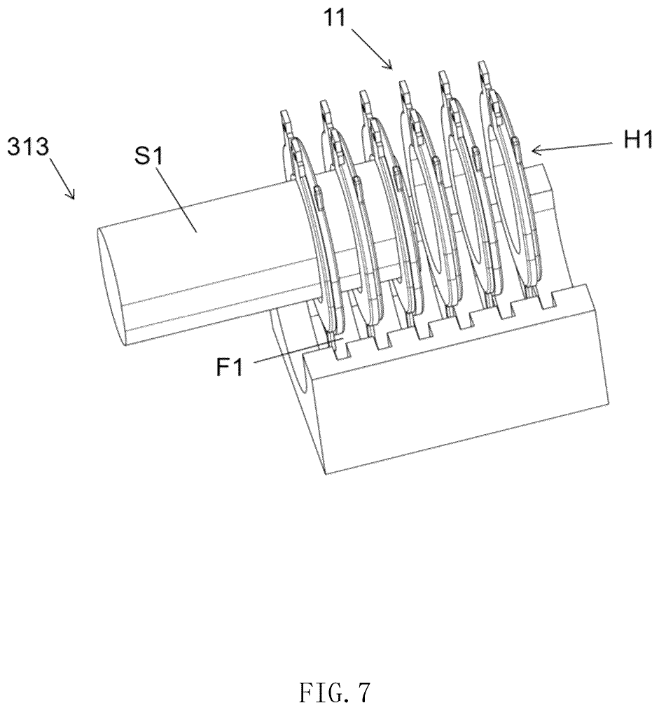

FIG. 7 is a schematic diagram of fixing the plurality of conductive layers 11 and the second mould 31. The plurality of conductive layers 11 are fixed in the plurality of third locating slots 311a, respectively, each of the conductive layers 11 has a first through hole H1, the fifth sub-mould 313 penetrates into the first through hole H1 of the plurality of conductive layers 11, and the plurality of conductive layers 11 are arranged at intervals sequentially on the fifth sub-mould 313.

A second mould 31 is obtained after a third sub-mould 311, a fourth sub-mould 312 and a fifth sub-mould 313 are combined, and a glue is injected into the second mould 31, and the plurality of conductive layers 11 and the glue form the magnetic element 10.

Specifically, referring to FIGS. 6 and 7, the fifth sub-mould 313 has a first curved surface S1, the two adjacent third locating slots 311a have a first surface F1 therebetween, correspondingly, the two adjacent fourth locating slots have a second surface therebetween, and the first surface F1 and the second surface form a second curved surface. A glue is injected between the first curved surface S1 and the second curved surface to form a plurality of second glue portions 12, each of the second glue portions 12 has an annular outer wall, and the plurality of second glue portions 12 are alternatively arranged with the plurality of conductive layers 11 to form the magnetic element 10 of FIG. 1. To facilitate observing, FIG. 6 depicts the plurality of conductive layers 11 and the plurality of second glue portions 12 separately, and depicts a position 11a, which corresponds to a position of the conductive layers 11, between the two adjacent second glue portions 12. In magnetic element products obtained from production, a body of the conductive layers is provided only at the position 11a without presence of the glue.

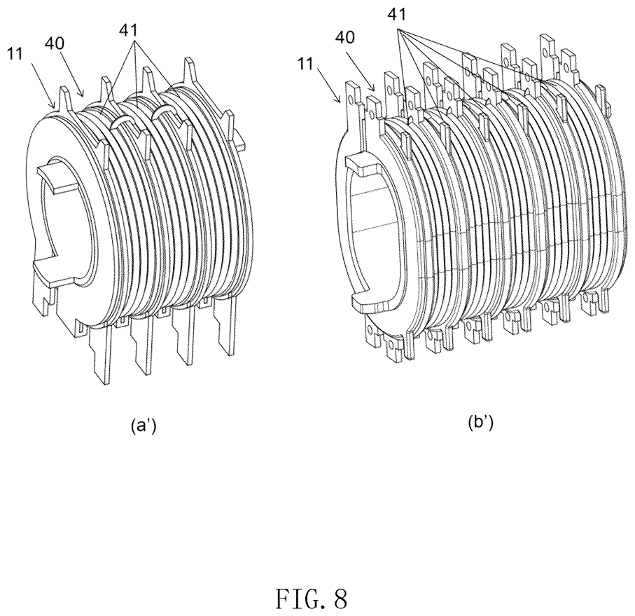

Corresponding to the two structures (a) and (b) of the magnetic element 10 shown in FIG. 1, FIG. 8 shows schematic diagrams (a′) and (b′) of a winding winded onto the magnetic element 10. Referring to FIGS. 1 and 8, the winding 40 includes a plurality of coil portions 41 winded onto the second glue portions 12 of the magnetic element 10, respectively, and the plurality of conductive layers 11 are alternatively arranged with the plurality of coil portions 41, and insulated through an insulation layer outside the coils. Pins of the winding can be selected according to actual situations, and are often arranged on the same side or different sides by a difference of 180°. The magnetic element 10 winded with the winding 40 can be further assembled with a magnetic core into a transformer.

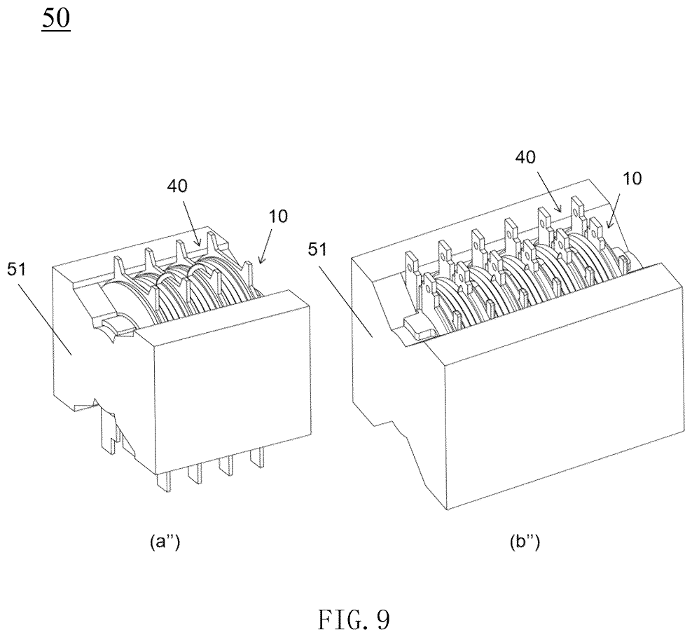

As shown in FIG. 9, a transformer 50 includes a magnetic core 51, the magnetic element 10 and a winding 40, the magnetic core 51 includes magnetic columns, which correspond to structures (a′) and (b′) shown in FIG. 8, and the magnetic element 10 may cooperate with the magnetic cores in different structures to obtain structures of the transformer 50, as shown in (a″) and (b″) of FIG. 9. The magnetic element 10 is disposed on the magnetic columns of the magnetic core 51 through a channel, and the plurality of coil portions 41 of the winding 40 are winded onto the second glue portions 12 of the magnetic element 10, respectively. A plurality of conductive layers 11 of a magnetic element 10 serve as secondary windings of the transformer 50, and a plurality of coil portions 41 serve as primary windings of the transformer 50. The plurality of conductive layers 11 may be connected in parallel or in series, and the plurality of coil portions 41 may be connected in parallel or in series.

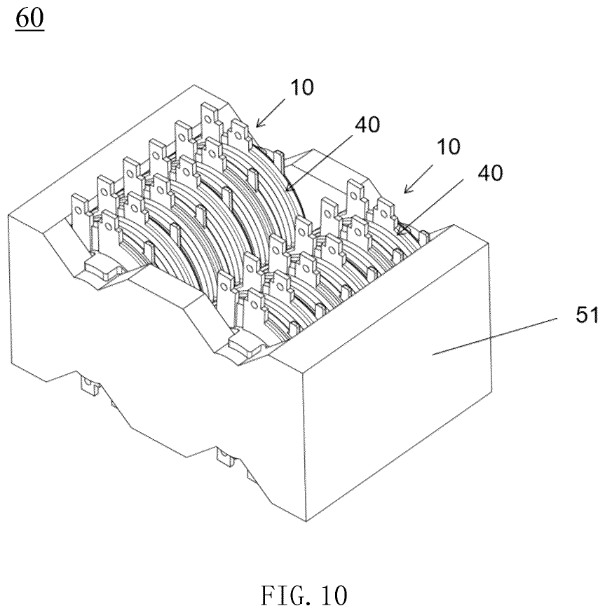

In some embodiments of the disclosure, magnetic columns in the magnetic core 51 also can be multiple columns. As shown in FIG. 10, a transformer 60 includes the magnetic core 51, the magnetic element 10 and the winding 40, the magnetic core 51 includes two magnetic columns, and each magnetic element 10 is disposed on one magnetic column correspondingly.

In some embodiments of the disclosure, type of the magnetic core may be E-shaped, U-shaped, P-shaped, or the like, but the disclosure is not limited thereto.

The magnetic elements provided in the disclosure have the following advantages:
(1) the conductive sheets are fixed by the locating surfaces and the locating slots on the first mould, the first injection is performed using the glue after the sub-moulds are combined, and the conductive sheets are fixed and insulated to obtain the conductive layers, which reduces the insulating tape material, and also saves an overall space of the products;
(2) firstly, the conductive layers are inserted into the locating slots of the second mould, and then combined through other structures of the second mould to conduct overall location, then the second injection is performed to combine the conductive layers into an integral body using the glue, thereby obtaining the magnetic element, production of the magnetic element uses an integrated way without manual assembly, and it is also not necessary to correct the finished products using the jigs, so accuracy of the products is also better;
(3) during injection moulding, the magnetic element has few open moulds and low cost;
(4) the magnetic element is injection moulded through the moulds, and the components are fixed using the glue, so automatic winding between the components may be performed stably;
(5) a tolerance of the conductive pins between the plurality of conductive layers is small, the assembly effect is good, and it is also not necessary to correct the finished products using jigs.

Although the embodiments of the disclosure have been illustrated and described, as for those ordinary in the art, it can be understood that these embodiments can have various changes, modifications, replacements and variations without departing from principle and spirit of the disclosure, and the protection scope of the disclosure is determined by the scope defined by the appended claims.

What is claimed is:

1. A method for forming a magnetic element, comprising:
providing a first sub-mould and a second sub-mould, the first sub-mould comprising a first locating slot, a first locating surface, a second locating slot and a second locating surface;
providing a first conductive sheet and a second conductive sheet both comprising a conductive body and a conductive pin;
fixing the conductive body of the first conductive sheet to the first locating surface, fixing the conductive pin of the first conductive sheet to the first locating slot, fixing the conductive body of the second conductive sheet to the second locating surface, and fixing the conductive pin of the second conductive sheet to the second locating slot;
obtaining a first mould after the first sub-mould and the second sub-mould are combined, and injecting a first glue into the first mould, the first conductive sheet, the second conductive sheet and the first glue forming a conductive layer;
providing a third sub-mould, a fourth sub-mould and a fifth sub-mould, the third sub-mould comprising a plurality of third locating slots;
preparing a plurality of conductive layers fixed to the plurality of third locating slots, each of the conductive layers having a first through hole, the fifth sub-mould penetrating into the first through hole of the plurality of conductive layers; and
obtaining a second mould after the third sub-mould, the fourth sub-mould and the fifth sub-mould are combined, and injecting a second glue into the second mould, the plurality of conductive layers and the second glue forming the magnetic element.

2. The method for forming a magnetic element according to claim 1, wherein the first conductive sheet and the second conductive sheet are metal sheets or PCB windings.

3. The method for forming a magnetic element according to claim 1, wherein shapes of the conductive body of the first conductive sheet and the first locating surface are matched with each other, shapes of the conductive pin of the first conductive sheet and the first locating slot are matched with each other, and shapes of the conductive pin of the second conductive sheet and the second locating slot are matched with each other.

4. The method for forming a magnetic element according to claim 1, wherein the first glue is injected between the first conductive sheet and the second conductive sheet to form a first glue portion, and the first conductive sheet and the second conductive sheet are fixed and insulated through the first glue portion.

5. The method for forming a magnetic element according to claim 1, wherein the conductive layer is a horizontal structure, and the first sub-mould and the second sub-mould are placed in an up and down form.

6. The method for forming a magnetic element according to claim 1, wherein the third sub-mould comprises a plurality of third locating slots, and the fourth sub-mould comprises a plurality of fourth locating slots corresponding to the third locating slots.

7. The method for forming a magnetic element according to claim 1, wherein the plurality of conductive layers are arranged at intervals sequentially on the fifth sub-mould.

8. The method for forming a magnetic element according to claim 1, wherein the second glue forms a plurality of second glue portions, each of the second glue portions has an annular outer wall, and the plurality of second glue portions are alternatively arranged with the plurality of conductive layers.

9. The method for forming a magnetic element according to claim 8, wherein the fifth sub-mould has a first curved surface, the adjacent third locating slots have a first surface therebetween, the adjacent fourth locating slots have a second surface therebetween, the first surface and the second surface form a second curved surface, and the second glue portions are formed between the first curved surface and the second curved surface.

10. The method for forming a magnetic element according to claim 8, wherein the second glue portions have second through holes correspondingly connected with each other to form a channel.

11. The method for forming a magnetic element according to claim 1, wherein the first glue and the second glue are thermoplastic materials.

12. The method for forming a magnetic element according to claim 1, wherein the conductive pin of the first conductive sheet and the conductive pin of the second conductive sheet are located on the same side or different sides.

13. The method for forming a magnetic element according to claim 1, wherein a tolerance of the conducive pins between the plurality of conductive layers is less than 0.1 mm.

14. A magnetic element, comprising:
a plurality of conductive layers, each comprising:
a first conductive sheet;
a second conductive sheet; and
a first glue portion disposed between the first conductive sheet and the second conductive sheet for fixing and insulating the first conductive sheet and the second conductive sheet, and
a plurality of second glue portions, each comprising an annular outer wall, and the plurality of second glue portions being alternatively arranged with the plurality of conductive layers,
wherein each of the conductive layers is injection moulded by the first conductive sheet and the second conductive sheet through a first mould, and the magnetic element is injection moulded by the plurality of conductive layers through a second mould.

15. The magnetic element according to claim 14, wherein the first conductive sheet and the second conductive sheet are metal sheets or PCB windings.

16. The magnetic element according to claim 14, wherein each of the conductive layers has a first through hole, and each of the second glue portions has second through holes correspondingly connected with each other to form a channel.

17. The magnetic element according to claim 14, wherein a tolerance of the conducive pins between the plurality of conductive layers is less than 0.1 mm.

18. The magnetic element according to claim 14, wherein the first glue portion and the second glue portions are thermoplastic materials.

19. A transformer, comprising:
a magnetic core comprising magnetic columns;
the magnetic element according to claim 14 disposed on the magnetic columns; and
a winding comprising a plurality of coil portions winded onto the plurality of integrated second glue portions, respectively.

20. The transformer according to claim 19, wherein,
the plurality of conductive layers are configured to secondary windings of the transformer, the plurality of coil portions are configured to primary windings of the transformer, and the plurality of conductive layers are alternatively arranged with the plurality of coil portions.
